(19) United States
(12) Patent Application Publication
(10) Pub. No.: US 2009/0247039 A1
(43) Pub. Date: Oct. 1, 2009

(54) INTRINSICALLY CONDUCTIVE THERMOPLASTIC COMPOSITION AND COMPOUNDING PROCESSING FOR MAKING CONDUCTIVE FIBER

(75) Inventors: Jayantha Amarasekera, Exton, PA (US); Bo Liu, Zachary, LA (US); Lawrence D. Lucco, Parkesburg, PA (US)

Correspondence Address: SABIC - LNP-CE 08CE;SABIC Innovative Plastics - IP LEGAL, ONE PLASTICS AVENUE, PITTSFIELD, MA, 01201-3697, US

(73) Assignee: SABIC INNOVATIVE PLASTICS IP BV, Pittsfield, MA (US)

(21) Appl. No.: 12/044,011

(22) Filed: Mar. 7, 2008

Related U.S. Application Data
(62) Division of application No. 11/609,147, filed on Dec. 11, 2006, now abandoned.

(51) Int. Cl. H01B 1/24; H01B 1/20; D02G 3/02; D04H 13/00; B82B 1/00

(52) U.S. Cl. 442/414; 252/500; 428/401; 252/511; 977/961; 977/742

(57) ABSTRACT

A conductive thermoplastic composition capable of forming conductive fibers including monofilaments, methods of making these compositions, and fibers including these compositions. The conductive thermoplastic compositions may be formed using any method capable of forming the compositions into fibers. The fibers are substantially smooth and/or are capable of being woven into fabrics or other articles to provide conductive properties to the fabric or article. These fibers provide effective static charge dissipation that may be imparted into applications such conveying belts or protective clothing for clean room operation.

### FIELD OF THE INVENTION

The application is a divisional application of U.S. application Ser. No. 11/609,147, filed Dec. 11, 2006, the contents of which are incorporated herein by reference thereto.

The present invention relates to thermoplastic compositions, and in particular to conductive thermoplastic compositions useful for forming conductive fibers.

### BACKGROUND OF THE INVENTION

Electrostatic charge is the result of a transfer of electrons that occurs due to the sliding, rubbing, or separation of material, which is a typical generator of electrostatic voltages. Under the right conditions, this induced charge can build to 30,000 to 40,000 volts. When this happens to an insulating material, the built-up charge tends to remain in the localized area of contact. The electrostatic voltage then can discharge through an arc or spark when the material comes in contact with a body of a sufficiently different potential, such as a human being or an electronic part. Those arcs or sparks can be very dangerous. For example, there is a potential fire hazard related to static sparking for an industrial conveying belts used in paper making industries. There is also a potential hazard of damaging electronic parts during handling due to electrostatic discharge (ESD). If electrostatic discharge occurs to a person, the results can range anywhere from a mild to a painful shock. In extreme cases, ESD could even result in loss of life. Therefore, it is important to effectively manage ESD. For example, at an operation where electric shock is subject to happen due to static electricity, protective clothing is necessary for operator's safety.

The surface resistivity spectrum is divided into four different classifications of material conductivity: anti-static materials with a surface resistivity in the range of 10̂9 to 10̂12 ohm/sq.; statically dissipative materials with a surface resistivity in the range of 10̂6 to 10̂9 ohm/sq.; conductive materials with a surface resistivity in the range of 10̂2 to 10̂5 ohm/sq.; and electrostatic shielding materials with a surface resistivity in the range of 10̂0 to 10̂2 ohm/sq. Anti-static materials can suppress initial charges and minimize the occurrence of tribocharging. They provide insulation against moderate to high leakage currents. Dissipative materials can prevent electrostatic discharge to/from human contact and provide insulation against high leakage currents. Conductive materials can dissipate tribocharging from high-speed motion and provide a grounding path for charge bleed-off. Electrostatic shielding materials can shield electromagnetic interference/radio frequency interference and block high electrostatic discharge voltages.

Polymers are typically electrically insulating materials with high surface resistivities in the range of 10̂14 to 10̂16 ohms/sq. It is known that polymers may be made conductive using electrically conductive fillers/additives such as carbon black, carbon fibers and metal powder. In one embodiment, metal powder has been used. Unfortunately, when using metal powder, a large quantity of the powder is necessary, which may adversely affect the properties of the composition since less polymer material is utilized. In addition, since metal powders are expensive, the costs associated with using metal powders make this solution less economically feasible.

In another proposed prior art solution, carbon fibers have been added to make the resulting compositions conductive. The addition of carbon fibers, however, leads to stiffening and to a reduction of impact strength and elongation at break, which is particularly disadvantageous if tubes or fibers are to be made from the conductive composition.

In addition, other prior art methods have involved the use of conductive coatings. However, these methods of treating plastics filaments or fibers with conductive coatings have many drawbacks including the decrease or even loss of electrical static dissipation properties due to wear-off of the coatings, as well as limited heat and hydrolytic stability of the coatings.

Accordingly, it would be beneficial to provide a thermoplastic composition capable of forming conductive fiber. It would also be beneficial to provide a method of making conductive materials capable of forming fibers including monofilaments. It would also be beneficial to provide conductive fibers and/or monofilaments capable of being woven to form fabrics and/or other articles having conductive properties.

### BRIEF SUMMARY OF THE INVENTION

The present invention provides a thermoplastic composition capable of forming conductive fiber, methods of making these compositions, and fibers including these compositions. The conductive thermoplastic resin of the present invention may be formed using a method, such as through melt spinning, into fibers that may then be woven into fabrics. The fibers formed using the compositions are substantially smooth and are capable of being woven into fabrics and/or other articles. These fibers provide effective static charge dissipation that may be imparted into applications such conveying belts or protective clothing for clean room operation. Those fibers including monofilaments or multifilament, as well as fabrics including the filaments or fibers, are conductive and may be used in any material handling process wherein safe dissipation of charge into the atmosphere is beneficial.

Accordingly, in one aspect, the present invention provides a thermoplastic composition that includes from 60 to 99% by weight of an organic polymer and from 0.5 to 40% by weight of a conductive filler; wherein the thermoplastic composition is capable of forming fibers.

In another aspect, the present invention provides fibers that include a thermoplastic composition that includes from 60 to 99% by weight of an organic polymer and from 0.5 to 40% by weight of a conductive filler and a conductive article that includes one or more of these fibers.

In still another aspect, the present invention provides method of forming a thermoplastic composition including the steps of dispersing 0.5 to 40% by weight of a conductive filler into 60 to 99% by weight of an organic polymer; wherein the thermoplastic composition is capable of forming fibers.

### BRIEF DESCRIPTION OF THE DRAWINGS

FIG. 1 is a representative appearance of monofilaments made using compositions of the present invention compared to prior art compositions observed using optical microscopy.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the term “comprising” may include the embodiments “consisting of” and “consisting essentially of.” All ranges disclosed herein are inclusive of the endpoints and are independently combinable. The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value.

The present invention provides a conductive thermoplastic composition capable of forming conductive fiber, methods of making these compositions, and fibers made from these compositions. The plastic fibers or filaments are substantially smooth and capable of being woven into fabrics or other articles. The fibers provide effective electrical static dissipation to articles containing fibers or filaments. The intrinsically conductive thermoplastic fibers or filaments have long-lasting electrical static dissipation effects and/or excellent environmental stability while also providing excellent physical properties as compared to prior art materials.

It is known that anti-static agent can be added to injection moldable polymer compounds to impart anti-static performance in the injection molded parts. Unfortunately, the same approach has not been successfully used for fiber application because of extremely high loading of anti-static agents that is often required. Since those anti-static agents are typically of low molecular weight small molecules or oligomer, fiber strength decreases quickly with the addition of a large amount of anti-static agents, which makes it not suitable for a fabric weaving process or other processes for integrating fibers into an article. The present invention shows a new approach of using a combination of permanent anti-static agent with conductive filler can be useful for making thermoplastic compositions that are capable of being formed into fibers including monofilaments that can then be used in the formation of fabrics or other articles having conductive properties.

The conductive thermoplastic compositions include an organic polymer capable of being extruded and a conductive filler. The conductive filler provides decreased resistances to the thermoplastic composition such that fibers or filaments made from the thermoplastic composition exhibit conductive properties. The thermoplastic compositions achieve the reduced resistances through the use of lesser amounts of conductive filler than prior art materials that enables the thermoplastic composition to have reduced resistances while also maintaining all or substantially all of the physical properties of the organic polymer. Therefore, unlike prior art conductive materials, the thermoplastic compositions of the present invention are capable of being formed into fibers including monofilaments that can then be used in the formation of fabrics or other articles having conductive properties.

As used herein, the term “capable of being formed into fibers” refers to a composition that forms a substantially smooth fiber as compared to compositions that form uneven fibers. Uneven fibers have thinner areas that are more susceptible to breakage when attempting to use these fibers to form articles. The “fibers” formed using the compositions of the present invention have a thickness that enables them to be capable of being woven or otherwise formed into an article, while not being too thin such that break easily during formation of the articles having conductive properties. In addition, these fibers have an average diameter that varies little along the length of the fiber. Accordingly, in one embodiment, the fibers of the present invention include single filaments that individually have a diameter between 0.05 mm and 0.8 mm. In an alternative embodiment, the fibers include single fibers or filaments that individually have a diameter between 0.08 mm and 0.5 mm. In yet another alternative embodiment, the fibers include single filaments that individually have a diameter between 0.1 mm and 0.3 mm. Additionally, in one embodiment, the fibers have an average diameter with a standard deviation of less than about 0.02 mm along the length of the fiber. In an alternative embodiment, the fibers have an average diameter with a standard deviation of less than about 0.015 mm along the length of the fiber. In still another embodiment, the fibers have an average diameter with a standard deviation of less than about 0.01 mm along the length of the fiber.

Compositions that are capable of being formed into fibers also refers to compositions that form fibers with sufficient flexibility to be woven or otherwise formed into an article without substantial breakage of the fibers during formation of the article, as well as having sufficient flexibility such that the fibers do not suffer substantial breakage when the article is used in normal operation. While it may be possible to form a fiber with some prior art compositions, these compositions form fibers that are uneven and/or that break during formation of conductive articles and/or use of the conductive articles. The compositions of the present invention, since they are capable of being formed into fibers, do not suffer the same drawbacks. As such, the fibers of the present invention are less brittle, have greater impact strength and/or better elongation at break properties as compared to fibers made from prior art materials.

In addition to being capable of being formed into fibers, the thermoplastic compositions also provide conductive properties to fibers formed from the compositions and articles that include these fibers. In order to provide conductive properties to the fiber, the compositions are sufficiently conductive such that the resulting fibers have, in one embodiment, a resistance equal to or less than 10¹⁰ ohms. In an alternative embodiment, the fibers have a resistance equal to or less than 10⁸ ohms. In still another embodiment, the fibers have a resistance equal to or less than 10⁶ ohms. In another aspect, the fibers have a specific resistance, in one embodiment, equal to or less than 10⁶ ohms-cm. In an alternative embodiment, the fibers have a specific resistance equal to or less than 10⁴ ohms-cm. In still another embodiment, the fibers have a specific resistance equal to or less than 10³ ohms-cm. As used herein, “specific resistance” refers to the electrical resistance offered by a material to the flow of current, times the cross-sectional area of current flow and per unit length of current path, whereas the “resistance” refers to the composition's opposition to the flow of electric current.

Accordingly, in one aspect, the present invention includes a thermoplastic composition having an organic polymer. The organic polymer serves as the base material for the thermoplastic composition. The organic polymer may be a crystalline polymer or an amorphous polymer. The organic polymer used in the conductive compositions may be selected from a wide variety of thermoplastic resins or blends of thermoplastic resins. The organic polymer may also be a blend of polymers, copolymers, terpolymers, or combinations including at least one of the foregoing organic polymers. Examples of the organic polymer include, but are not limited to, polyacetals, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or the like, or a combination including at least one of the foregoing organic polymers.

In one embodiment, polyimides may be used as the organic polymers in the thermoplastic compositions. Useful thermoplastic polyimides have the general formula (I)

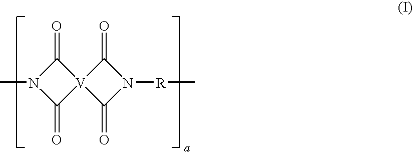

wherein a is, in one embodiment, greater than or equal to 10, and in another embodiment greater than or equal to 1000; and wherein V is a tetravalent linker without limitation, as long as the linker does not impede synthesis or use of the polyimide. Suitable linkers include (a) substituted or unsubstituted, saturated, unsaturated or aromatic monocyclic and polycyclic groups having 5 to 50 carbon atoms, (b) substituted or unsubstituted, linear or branched, saturated or unsaturated alkyl groups having 1 to 30 carbon atoms; or combinations thereof. Suitable substitutions and/or linkers include, but are not limited to, ethers, epoxides, amides, esters, and combinations thereof. Exemplary linkers include, but are not limited to, tetravalent aromatic radicals of formula (II), such as

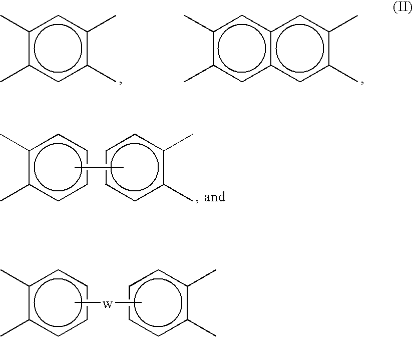

wherein W is a divalent moiety selected from —O—, —S—, —C(O)—, —SO₂—, —SO—, —C_{y}H_{2y}— (y being an integer from 1 to 5), and halogenated derivatives thereof, including perfluoroalkylene groups, or a group of the formula —O-Z-O— wherein the divalent bonds of the —O— or the —O-Z-O— group are in the 3,3′, 3,4′, 4,3′, or the 4,4′ positions, and wherein Z includes, but is not limited, to divalent radicals of formula (III).

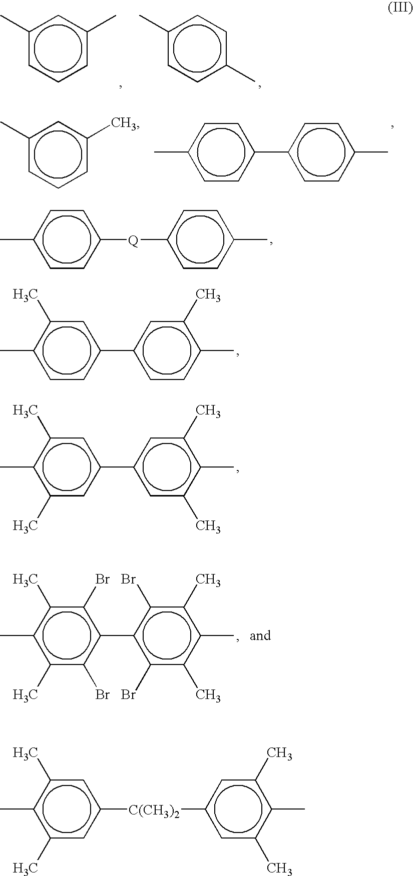

R in formula (I) includes substituted or unsubstituted divalent organic radicals such as (a) aromatic hydrocarbon radicals having 6 to 20 carbon atoms and halogenated derivatives thereof, (b) straight or branched chain alkylene radicals having 2 to 20 carbon atoms; (c) cycloalkylene radicals having 3 to 20 carbon atoms, or (d) divalent radicals of the general formula (IV)

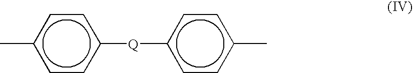

wherein Q includes a divalent moiety selected from —O—, —S—, —C(O)—, —SO₂—, —SO—, —C_{y}H_{2y}— (y being an integer from 1 to 5), and halogenated derivatives thereof, including perfluoroalkylene groups.

Exemplary classes of polyimides that may be used in the thermoplastic compositions include polyamidimides and polyetherimides, particularly those polyetherimides that are melt processable.

Beneficial polyetherimide polymers include in one embodiment more than 1, in another embodiment 10 to 1000 or more, and in still another embodiment 10 to 500 structural units, of the formula (V)

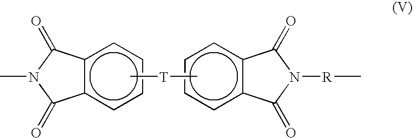

wherein T is —O— or a group of the formula —O-Z-O— wherein the divalent bonds of the —O— or the —O-Z-O— group are in the 3,3′, 3,4′, 4,3′, or the 4,4′ positions, and wherein Z includes, but is not limited, to divalent radicals of formula (III) as defined above.

In one embodiment, the polyetherimide may be a copolymer, which, in addition to the etherimide units described above, further contains polyimide structural units of the formula (VI)

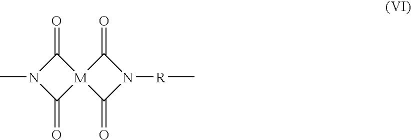

wherein R is as previously defined for formula (I) and M includes, but is not limited to, radicals of formula (VII).

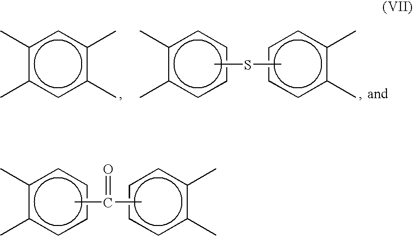

The polyetherimide may be prepared by any of the methods including the reaction of an aromatic bis(ether anhydride) of the formula (VIII)

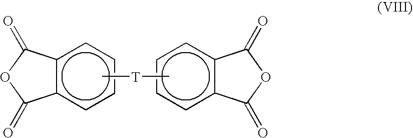

with an organic diamine of the formula (IX)

H₂N—R—NH₂ (IX)

wherein T and R are defined as described above in formulas (I) and (IV).

Illustrative examples of aromatic bis(ether anhydride)s of formula (VIII) include 2,2-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, as well as various mixtures thereof.

The bis(ether anhydride)s may be prepared by the hydrolysis, followed by dehydration, of the reaction product of a nitro substituted phenyl dinitrile with a metal salt of dihydric phenol compound in the presence of a dipolar, aprotic solvent. A beneficial class of aromatic bis(ether anhydride)s included by formula (VIII) above includes, but is not limited to, compounds wherein T is of the formula (X)

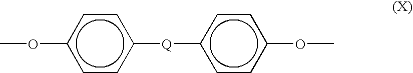

and the ether linkages, for example, are beneficially in the 3,3′, 3,4′, 4,3′, or 4,4′ positions, and mixtures thereof, and where Q is as defined above.

Any diamino compound may be employed in the preparation of the polyimides and/or polyetherimides. Examples of suitable compounds are ethylenediamine, propylenediamine, trimethylenediamine, diethylenetriamine, triethylenetertramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylenediamine, 1,2-bis(3-aminopropoxy)ethane, bis(3-aminopropyl)sulfide, 1,4-cyclohexanediamine, bis-(4-aminocyclohexyl)methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl)methane, bis(2-chloro-4-amino-3,5-diethylphenyl)methane, bis(4-aminophenyl)propane, 2,4-bis(b-amino-t-butyl)toluene, bis(p-b-amino-t-butylphenyl)ether, bis(p-b-methyl-o-aminophenyl)benzene, bis(p-b-methyl-o-aminopentyl)benzene, 1,3-diamino-4-isopropylbenzene, bis(4-aminophenyl)sulfide, bis(4-aminophenyl)sulfone, bis(4-aminophenyl)ether and 1,3-bis(3-aminopropyl)tetramethyldisiloxane. Mixtures of these compounds may also be present. In one embodiment, the diamino compounds are aromatic diamines, especially m- and p-phenylenediamine and mixtures thereof.

In an exemplary embodiment, the polyetherimide resin includes structural units according to formula (V) wherein each R is independently p-phenylene or m-phenylene or a mixture thereof and T is a divalent radical of the formula (XI)

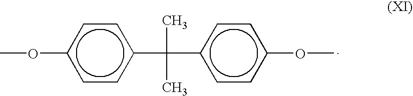

Generally, useful polyetherimides have a melt index of 0.1 to 10 grams per minute (g/min), as measured by Amerimay Society for Testing Materials (ASTM) D1238 at 295° C., using a 6.6 kilogram (kg) weight. In one embodiment, the polyetherimide resin has a weight average molecular weight (Mw) of 10,000 to 150,000 grams per mole (g/mole), as measured by gel permeation chromatography, using a polystyrene standard. Such polyetherimide polymers typically have an intrinsic viscosity greater than 0.2 deciliters per gram (dl/g), beneficially 0.35 to 0.7 dl/g measured in m-cresol at 25° C.

In another embodiment, the organic polymers include polyesters. The high molecular weight polyesters used in the practice of the present invention are polymeric glycol esters of terephthalic acid and isophthalic acid. They are widely available commercially. Otherwise they can be readily prepared by known techniques, such as by the alcoholysis of esters of terephthalic and/or isophthalic acid with a glycol and subsequent polymerization, by heating glycols with free acids or with halide derivatives thereof, and similar processes.

Although the glycol portion of the polyester can contain from 2 to 10 atoms in one embodiment, the glycol portion, in another embodiments, can contain from 2 to 4 carbon atoms in the form of linear methylene chains.

Exemplary polyesters will be of the family including high molecular weight polymeric glycol terephthalates or isophthalates having repeating units of the general formula (XII)

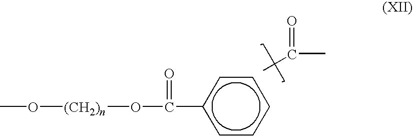

wherein n is a whole number of from 2 to 4, and mixtures of such esters, including copolyesters of terephthalic and isophthalic acids of up to 30 mole percent isophthalic units.

Especially beneficial polyesters are poly(ethylene terephthalate) and poly(1,4-butylene terephthalate). Special mention is made of the latter because it crystallizes at such a good rate without the need for nucleating agents or long cycles, as is sometimes necessary with poly(ethylene terephthalate).

Illustratively, high molecular weight polyesters, such as poly(1,4-butylene terephthalate), will have an intrinsic viscosity of at least about 0.7 deciliters/gram and, in alternative embodiments, at least 0.8 deciliters/gram as measured in a 60:40 phenol tetrachloroethane mixture at 30° C. At intrinsic viscosities of at least about 1.0 deciliters/gram, there is further enhancement of toughness of the present compositions.

As will be understood by those skilled in the art, the poly(1,4-butylene terephthalate) block can be straight chain or branched, e.g., by use of a branching component which contains at least 3 ester-forming groups. This can be a polyol, e.g., pentaerythritol, trimethylolpropane, and the like, or a polybasic acid compound, e.g., trimethyl trimesitate, and the like.

In addition to the organic polymer, the thermoplastic compositions of the present invention include at least one conductive filler. The conductive filler is chosen such that the resulting thermoplastic composition is capable of being formed into fibers. As such, not all conductive fillers can be used in the present invention, only those that permit the resulting thermoplastic composition to be capable of being formed into fibers. In one embodiment, the conductive filler is a low-structure carbon black. A “low-structure carbon black is one that has a lower surface area. In one embodiment, the low-structure carbon black has a surface area less than 300 m²/g. In another embodiment, the low-structure carbon black has a surface area less than 200 m²/g. In still another embodiment, the low-structure carbon black has a surface area less than 150 m²/g.

In an alternative embodiment, either alone or in conjunction with a low-structure carbon black, the conductive filler may include carbon nanotubes. In one embodiment, the carbon nanotubes are single-wall nanotubes while in an alternative embodiment; the carbon nanotubes are multi-wall nanotubes. Other conductive fillers that may be used in the present invention include, but are not limited to, metal coated mineral particles, small metal particles, vapor grown carbon tubes, and/or any other conductive filler that permits the resulting thermoplastic composition to be capable of being formed into fibers.

The amount of filler used in the thermoplastic composition is dependent on one more factors including, but not limited to, the organic polymer used, the type of conductive filler used, the presence of additional polymers, the size of the fibers to be formed, the application in which the fibers will be used, and/or the presence of any other additives or fillers. In one embodiment, the amount of conductive filler added is from 0.5 to 40% by weight of the thermoplastic composition. In another embodiment, the amount of conductive filler added is from 1 to 35% by weight of the thermoplastic composition. In still another embodiment, the amount of conductive filler added is from 2 to 30% by weight of the thermoplastic composition.

In alternative embodiments of the present invention, other polymers can be included depending on the selected properties of the thermoplastic compositions and/or the fibers made from the thermoplastic composition. In one embodiment, the thermoplastic compositions include a polyamide/polyetheramide copolymer as part of the thermoplastic composition. In one embodiment, the polyamide/polyetheramide copolymer is included in an amount from 1 to 40% by weight of the total weight of the thermoplastic composition. In another embodiment, the polyamide/polyetheramide copolymer is included in an amount from 10 to 35% by weight of the total weight of the thermoplastic composition. In still another embodiment, the polyamide/polyetheramide copolymer is included in an amount from 15 to 35% by weight of the total weight of the thermoplastic composition.

The thermoplastic compositions of the present invention may be formed using any known method of dispersing a conductive filler in an organic polymer. In one embodiment, the organic polymer has a sufficient molecular weight to enable the filler to be dispersed in the organic polymer using an extrusion process. When an extrusion process is used, it has been discovered that higher process speeds provide generally better dispersion of the conductive filler in the organic polymer. In one embodiment, the extruder has a screw speed operating at 250 RPM or above. In another embodiment, the extruder has a screw speed operating at 300 RPM or above. In still another embodiment, the extruder has a screw speed operating at 375 RPM or above. The method of determining the method of dispersing the filler and/or the operating parameters of the method may be based upon one or more factors including, but not limited to, the type and/or amount of conductive filler, the type and/or amount of the organic polymer, the selected resistivity of the fibers, the presence of other additives, the screw deign (for extruders), and/or the application in which the fibers will be used.

The fibers may be formed using any known method capable of forming a fiber using a thermoplastic composition. Examples include, but are not limited to, wet spinning, dry spinning, melt spinning, gel spinning, or a combination including one or more of the foregoing methods. The method used may be based on one or more factors including, but not limited to, the type of organic polymer used, the type of conductive polymer use, and/or the thickness of the fibers to be formed.

The compositions of the present invention may include one or more additional additives provided the resulting thermoplastic compositions are still capable of forming fibers. Examples of additional additives include, but are not limited to, flame-retardant agents, antidrip agents, heat stabilizers, light stabilizers, antioxidants, plasticizers, antistat agents, mold release agents, UV absorbers, lubricants, pigments, dyes, colorants, or combinations including one or more of the foregoing. When used, these additives total from 0.1 to 10% by weight of the total weight of the thermoplastic composition.

The present invention is further illustrated by the following non-limiting examples.

### EXAMPLES

A first set of experiments was performed to evaluate multiple conductive thermoplastic compositions to determine whether they provided adequate conductive characteristics and to determine whether they were capable of being formed into fibers including monofilaments that could then be used in one or more subsequent applications.

For each of these samples, the conductive thermoplastic compositions were formed using an extrusion process. A 25 mm 10 barrel Werner & Pfleiderer twin-screw extruder with a screw designed for improving distributive dispersion was used to make the samples. The zone temperatures were set in the range of 237 to 249° C. for PBT based materials, while for PEI based material, the zone temperatures were set at 369 to 372° C.

Pellets were dried using a MaGuire low pressure vacuum dryer for 1 hour before injection molding into testing specimens using a 220-ton Cincinnati injection-molding machine. Melt temperatures were 490° F. and 700° F. for PBT and PEI, respectively. Mold temperatures were 200° F. and 300° F. for PBT and PEI, respectively.

Molten strands were generated from a capillary rheometer with a die of 1 mm in diameter. The barrel setting temperature varied with the materials under evaluation. The molten strands then went over a deflection wheel in the air before they were attached to a torque winder for drawing down into fiber. Torque winder speed was set at 99 ft/min.

Both surface resistivity and volume resistivity were measured on molded 3″×5″×0.125″ plaques using Dr. Thiedig MILLI-TO 2 resistance meter if the reading is below 10̂7 and Hewlett Packard high resistance meter for any readings above 10̂7 per ASTM standard D 4496 & D257. Resistance of the fiber specimens were measured using PRS-801 Resistance Test System with an applied voltage of 10V. The specific resistance of the fiber was calculated as:

Specific Resistance=R*A/L

R is resistance

A is the cross-section area of the filament

L is the length of the filament measured

The materials used in the experiments were as follows:
PBT: VALOX™ 315: IV is 1.2 dg/l and acid number is 33 to 43 meq/kg. Mw=110000
PEI: ULTEM™ 1010: Tg=217 C, Melt Flow Rate=17.8 g/10 min at 337 C and 6.6 kgf
Low-structure conductive carbon black-1 (LCB-1): Erachem Ensaco 250, surface area 65 m²/g, sulphur content: <0.05%
Low-structure conductive carbon black-2 (LCB-2): Cabot Vulcan XC72: surface area 254 m²/g, sulphur content: 0.6%
High-structure conductive carbon black-1 (HCB-1): Akzo Ketjen EC-300J, surface area 795 m²/g
High-structure conductive carbon black-2 (HCB-2): Akzo Ketjen EC-600JD, surface area 1250-1353 m²/g
Chopped carbon fiber: Toho F202, 7 micron in diameter, ⅛″ in length
Multi-wall carbon nano tube masterbatch: Hyperion MB5015-00, 15% in PBT
PA/PEA copolymer: Polyamide/polyether amide copolymer, Ciba IRGASTAT™ P 20

Both semi-crystalline thermoplastic polymer such polybutylene terephthalate (“PBT”) and amorphorous thermoplastic polymer such as polyetherimide (“PEI”) were evaluated in this invention.

The fiber properties of PBT with various conductive fillers are shown in Table 1. Formulation 1 is polybutylene terephthalate (“PBT”) with low-structure carbon black LCB-1. Formulations 2 and 3 are PBT with two high-structure carbon blacks. High Structure HCB-2 has higher surface area than High Structure HCB-1. As shown, although both low-structure and high structure carbon blacks result in fiber resistance in a range of 10̂5 ohm to 10̂6 ohm and specific resistance in a range of 10̂2 to 10̂3 ohm-cm, only low-structure carbon black in Formulation 1 yields good fiber. With high-structure carbon blacks, no fibers with acceptable appearance and integrity could be made. Low-structure carbon black has surprisingly good effects on making fibers that are conductive and capable of electric charge dissipation.

A loading range from 17 to 1% was examined with Formulations 4 to 7 using low-structure carbon black LCB-1 in PBT. Higher loadings up to 25% were examined and the data are shown with Formulations 12 to 13 in Table 2. An increase in the loading of low-structure carbon black LCB-1 would reduce both fiber resistance and specific resistance. PA/PEA copolymer was incorporated to further reduce the resistance in fibers. Fiber resistance of 10̂10 ohm or less may be achieved from those formulations. The specific resistance of 10̂6 ohm-cm or less may be obtained as well.

From the Table 1, we can see that combination of a permanent anti-static agent, such as PA/PEA copolymer with low-structure carbon black, such as LCB-1 in Formulation 4 provides a lower resistance and specific resistance than both using low-structure carbon black alone (in Formulation 1) or using predominately PA/PEA copolymer (in Formulation 7). There is a synergistic effect of combining permanent anti-static agent with low-structure carbon black.

A similar study was carried out to evaluate the effect of loading using high-structure carbon blacks in PBT. As shown by Formulation 9 to 11, an increase in the loading of high-structure carbon black HCB-2 would reduce both fiber resistance and specific resistance. PA/PEA copolymer was also incorporated to reduce the resistance in fibers. At the same loading of 10% high-structure carbon black HCB-1, 25% PA/PEA copolymer lowers the fiber resistance from 10̂6 ohm to 10̂5 ohm when comparing Formulation 8 with Formulation 2. As may be seen from the results, although high-structure carbon black at those loadings may impart fiber resistance sufficient for electrical charge dissipation, they are not able to result in good fibers.

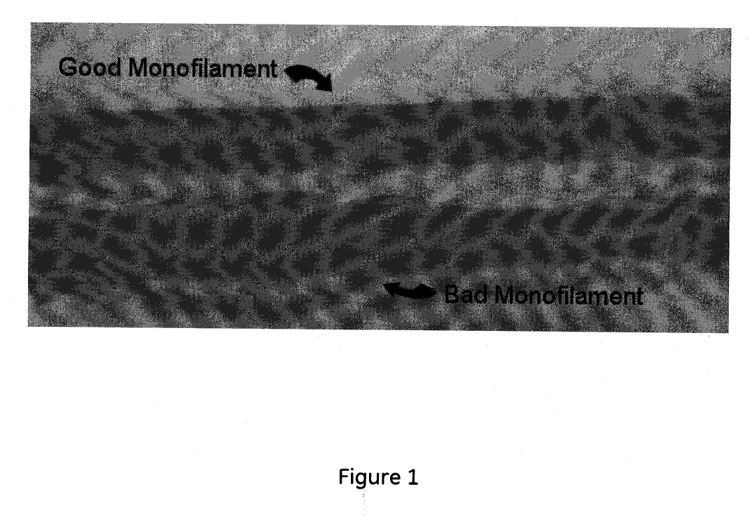

FIG. 1 is a representative appearance of the fibers observed using optical microscopy. The top fiber shown in the picture is made of low-structure carbon black, such as Formulation #1 and it is smooth and uniform. In contrast, the bottom fiber made of high-structure carbon black, such as Formulation #2 is rough and uneven. The uneven filaments are not acceptable, as they tend to break during a fabric weaving process.

TABLE 1
Compositions And Properties of PBT Filled With Conductive Carbon
Blacks And The Fibers Made Of Those Compositions

| | Formulation | | | | | | | | | | |
|---|---|---|---|---|---|---|---|---|---|---|---|
| | 1 | 2 | 3 | 4 | 5 | 6 | 7 | 8 | 9 | 10 | 11 |
| PBT | 82.50 | 89.50 | 91.50 | 57.50 | 60.50 | 63.50 | 73.50 | 64.50 | 66.50 | 68.50 | 70.50 |
| PA/PEA | | | | 25.00 | 25.00 | 25.00 | 25.00 | 25.00 | 25.00 | 25.00 | 25.00 |
| copolymer | | | | | | | | | | | |
| Low-structure | 17.00 | | | 17.00 | 14.00 | 11.00 | 1.00 | | | | |
| LCB-1 | | | | | | | | | | | |
| High-structure | | 10.00 | | | | | | 10.00 | | | |
| HCB-1 | | | | | | | | | | | |
| High-structure | | | 8.00 | | | | | | 8.00 | 6.00 | 4.00 |
| HCB-2 | | | | | | | | | | | |
| Heat Stabilizer | 0.50 | 0.50 | 0.50 | 0.50 | 0.50 | 0.50 | 0.50 | 0.50 | 0.50 | 0.50 | 0.50 |
| Fiber Appearance | SMOOTH | UNEVEN | UNEVEN | SMOOTH | SMOOTH | SMOOTH | SMOOTH | UNEVEN | UNEVEN | UNEVEN | UNEVEN |
| | GOOD | BAD | BAD | GOOD | GOOD | GOOD | GOOD | BAD | BAD | BAD | BAD |
| Electrical | | | | | | | | | | | |
| Properties | | | | | | | | | | | |
| of Fiber | | | | | | | | | | | |
| Length, mm | 50 | 50 | 50 | 60 | 60 | 60 | 50 | 50 | 50 | 50 | 50 |
| Resistance, ohm | 3.2E+05 | 1.3E+06 | 3.2E+05 | 8.6E+04 | 3.2E+06 | 8.9E+10 | 1.6E+11 | 3.1E+05 | 3.4E+05 | 4.8E+05 | 1.3E+07 |
| Specific | 22 | 132 | 18 | 5 | 95 | 3.E+06 | 1.E+07 | 18 | 19 | 27 | 720 |
| Resistance, | | | | | | | | | | | |
| ohm-cm | | | | | | | | | | | |
| Mechanical | | | | | | | | | | | |
| Properties | | | | | | | | | | | |
| Tensile Modulus, | 0.518 | 0.472 | 0.458 | 0.32 | 0.319 | 0.309 | 0.279 | 0.29 | 0.271 | 0.269 | 0.268 |
| msi | | | | | | | | | | | |
| Notched Izod | 0.68 | 0.59 | 0.63 | 1.1 | 1.29 | 1.38 | 1.9 | 1.08 | 1.01 | 1.21 | 1.32 |
| Impact, ft-lb/in | | | | | | | | | | | |
| Electrical | | | | | | | | | | | |
| Properties of | | | | | | | | | | | |
| Molded Plaques | | | | | | | | | | | |
| Surface | 5.5E+01 | 1.6E+02 | 1.8E+02 | 3.1E+01 | 1.3E+02 | 4.5E+09 | 7.9E+10 | 6.6E+01 | 1.6E+02 | 3.0E+02 | 1.3E+06 |
| Resistivity, | | | | | | | | | | | |
| ohm/sq | | | | | | | | | | | |
| Volume | 6.0E+01 | 2.4E+02 | 1.4E+02 | 8.7E+01 | 5.2E+02 | 5.6E+09 | 4.2E+11 | 1.3E+02 | 9.7E+01 | 3.0E+02 | 1.1E+07 |
| Resisitivity, | | | | | | | | | | | |
| ohm-cm | | | | | | | | | | | |
| Fiber Processing | | | | | | | | | | | |
| Information | | | | | | | | | | | |
| Temperature, C. | 255 | 255 | 255 | 235 | 235 | 235 | 235 | 235 | 235 | 235 | 235 |
| Average | 0.210 | 0.252 | 0.196 | 0.219 | 0.151 | 0.158 | 0.218 | 0.190 | 0.212 | 0.201 | 0.192 |
| Diameter, mm | | | | | | | | | | | |
| Std. Deviation | 0.007 | 0.084 | 0.067 | 0.008 | 0.006 | 0.007 | 0.005 | 0.069 | 0.079 | 0.052 | 0.031 |
| Diameter, mm | | | | | | | | | | | |

As may be seen from these examples, not all conductive fillers could be used to form thermoplastic compositions capable of being formed into fibers. Regardless of the organic polymer or combination of organic polymers or the amount of conductive filler used, those fibers formed using high structure carbon black had an uneven appearance and an average fiber diameter that varied widely (i.e. having a standard deviation of at least 0.03 mm) whereas fibers formed using the low-structure carbon black all had a substantially smooth appearance and an average fiber diameter that varied little (i.e. having a standard deviation of 0.02 mm or less).

As shown in Table 2, although sulfur content of low-structure carbon black LCB-2 is higher than low-structure carbon black LCB-1, PBT filled with either of those low-structure carbon blacks can be made into fibers with smooth appearance and an average fiber diameter that varied little (i.e. having a standard deviation of less than 0.02 mm). A loading range from 20 to 25% was examined with Formulations 12-13 for LCB-1 and Formulation 14-15 for LCB-2. Fiber resistance of 10̂5 ohm or less may be achieved from those formulations. The specific resistance of 10̂1 ohm-cm or less may be obtained as well.

TABLE 2
Compositions And Properties Of PBT Filled With Low-Structure
Conductive Carbon Blacks And The Fibers Made Of Those Compositions

| | Formulation | | | |
|---|---|---|---|---|
| | 12 | 13 | 14 | 15 |
| PBT | 79.50 | 90.00 | 79.50 | 90.00 |
| Low-structure LCB-1 | 20.00 | 25.00 | | |
| Low-structure LCB-2 | | | 20.00 | 25.00 |
| Heat Stabilizer | 0.50 | 0.50 | 0.50 | 0.50 |
| Monofilament Appearance | SMOOTH | SMOOTH | SMOOTH | SMOOTH |
| | GOOD | GOOD | GOOD | GOOD |
| Electrical Properties of Monofilament | | | | |
| Length, mm | 50 | 50 | 50 | 50 |
| Resistance, ohm | 9.1E+04 | 4.6E+04 | 9.1E+04 | 5.0E+04 |
| Specific Resistance, ohm-cm | 5 | 2 | 5 | 2 |
| Mechanical Properties | | | | |
| Tensile Modulus, msi | 0.53 | 0.58 | 0.54 | 0.60 |
| Electrical Properties of Molded Plaques | | | | |
| Surface Resistivity, ohm/sq | 20 | 9 | 20 | 9 |
| Volume Resisitivity, ohm-cm | 71 | 62 | 71 | 62 |
| Monofilament Processing Information | | | | |
| Temperature, C. | 250 | 250 | 250 | 250 |
| Average Diameter, mm | 0.195 | 0.160 | 0.195 | 0.140 |
| Std. Deviation, mm | 0.009 | 0.011 | 0.010 | 0.012 |

In the next set of formulations, polyetherimide (“PEI”) was used as the thermoplastic substrate instead of PBT. Table 3 lists the fiber properties of PEI with carbon blacks. Formulations 16 and 17 are PEI with low-structure carbon black LCB-1 and high-structure carbon black HCB-1, respectively. Similar to PBT, only low-structure carbon black was capable of yielding satisfactory fibers that were also electrically conductive. No uniform and smooth fibers could be made with PEI filled with high-structure carbon black and those fibers formed using high structure carbon black had an average fiber diameter that varied widely whereas fibers formed using the low-structure carbon black had an average fiber diameter that varied little.

TABLE 3
Compositions And Properties of PEI Filled With Conductive Carbon
Blacks And The Fibers Made Of Those Compositions

Formulation

| | 16 | 17 |
|---|---|---|
| PEI | 83.00 | 90.00 |
| High-structure HCB-1 | | 10.00 |
| Fiber Appearance | SMOOTH | UNEVEN |
| | GOOD | BAD |
| Electrical Properties of Fiber | | |
| Length, mm | 50 | 50 |
| Resistance, ohm | 2.5E+06 | 6.5E+06 |
| Specific Resistance, ohm-cm | 153 | 401 |
| Mechanical Properties | | |
| Tensile Modulus, msi | 0.618 | 0.584 |
| Notched Izod Impact, ft-lb/in | 0.57 | 0.54 |
| Electrical Properties of Molded Plaques | | |
| Surface Resistivity, ohm/sq | 1.5E+03 | 4.9E+03 |
| Volume Resisitivity, ohm-cm | 1.5E+03 | 7.3E+03 |
| Fiber Processing Information | | |
| Temperature, C. | 370 | 370 |
| Average Diameter, mm | 0.199 | 0.198 |
| Std. Deviation Diameter, mm | 0.005 | 0.035 |

In the next formulations, the use of carbon nanotubes and carbon fibers were investigated as alternative conductive fillers. As shown in Table 4, multi-wall carbon nanotubes (MWNT) of low concentration (such as 3% in Formulation 18 and 4.95% in Formulation 19) may impart high conductivity in PBT fibers. At those loadings, fiber resistance of 10̂8 ohm and the specific resistance of 10̂4 ohm-cm can be obtained. On the contrary, chopped carbon fibers (in Formulation 20 and Formulation 21) could not impart conductivity in fibers, even at a loading as high as 17%.

TABLE 4
Compositions And Properties of PBT Filled With Chopped Carbon Fibers
And Multi-Wall Nano-Tubes And The Fibers Made Of Those
Compositions

| | Formulation | | | |
|---|---|---|---|---|
| | 18 | 19 | 20 | 21 |
| PBT | 71.50 | 94.55 | 57.50 | 82.50 |
| PA/PEA copolymer | 25.00 | | 25.00 | |
| Chopped CF | | | 17.00 | 17.00 |
| MWNT | 3.00 | 4.95 | | |
| Heat Stabilizer | 0.50 | 0.50 | 0.50 | 0.50 |
| Fiber Appearance | SMOOTH | SMOOTH | LOTS OF | LOTS OF |
| | GOOD | GOOD | BREAKAGE, | BREAKAGE, |
| | | | UNEVEN | UNEVEN |
| | | | BAD | BAD |
| Electrical Properties of Fiber | | | | |
| Length, mm | 50 | 50 | 50 | 50 |
| Resistance, ohm | 6.6E+08 | 1.9E+08 | 6.5E+12 | 1.7E+13 |
| Specific Resistance, ohm-cm | 3.8E+04 | 1.1E+04 | 6.E+08 | 3.E+09 |
| Mechanical Properties | | | | |
| Tensile Modulus, msi | 0.291 | 0.469 | 0.916 | 1.31 |
| Notched Izod Impact, ft-lb/in | 1.5 | 0.9 | 1.25 | 0.88 |
| Electrical Properties of Molded Plaques | | | | |
| Surface Resistivity, ohm/sq | 8.1E+07 | 1.4E+05 | 2.7E+02 | 2.0E+04 |
| Volume Resisitivity, ohm-cm | 1.8E+08 | 9.2E+05 | 5.6E+02 | 2.0E+05 |
| Fiber Processing Information | | | | |
| Temperature, C. | 235 | 245 | 235 | 255 |
| Average Diameter, mm | 0.19 | 0.195 | 0.244 | 0.351 |
| Std. Deviation Diameter, mm | 0.018 | 0.013 | 0.107 | 0.113 |

As with the compositions using high-structure carbon black, regardless of the organic polymer or combination of organic polymers or the amount of conductive filler used, those fibers formed using chopped carbon fiber as the conductive filler had an uneven appearance and an average fiber diameter that varied widely whereas fibers formed using the multi-wall carbon nanotubes all had a substantially smooth appearance and an average fiber diameter that varied little.

Lastly, the effects of processing parameters were investigated to determine the effect of these processing parameters on the final properties of the fibers. An extrusion processing experiment was conducted using Formulation #1 to evaluate the effects of processing parameters. As shown in Table 5, a screw speed higher than 250 was beneficial, while a screw speed higher than 375 even more beneficial in order to obtain better dispersion of the fillers and achieve a resistance lower than 10E+09 ohm in a resulting fiber.

TABLE 5
Effects Of Compounding Screw Speed On Electrical Properties Of Fibers
Made Of PBT Filled With Low-Structure Carbon Black LCB-1

| | | | | |
|---|---|---|---|---|
| Extrusion Processing | | | | |
| Condition | | | | |
| Rate | 30 | 30 | 30 | 30 |
| Screw Speed | 250 | 375 | 450 | 575 |
| Electrical Properties of | | | | |
| Fiber | | | | |
| Resistance, ohm | 1.90E+09 | 3.3E+06 | 3.2E+05 | 1.26E+05 |
| Specific resistance SR, | 109387 | 98 | 22 | 7 |
| ohm-cm | | | | |

The compositions of the present invention are especially useful in any applications wherein conductive properties are beneficial. Due to the low specific resistance of fibers formed using these thermoplastic compositions, fabrics or other articles that include these fibers are capable of dissipating any electric or static charge that might build up during use of the article. As such, the risk of shock or fire due to sudden discharge of this charge is substantially reduced. Examples of such applications include, but are not limited to, conveyor belts, electronic parts handling applications, protective clothing, and the like.

As set forth herein, compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substitute. For example, —CHO is attached through carbon of the carbonyl group. Unless defined otherwise, technical and scientific terms used herein have the same meaning as is commonly understood by one of skill in the art to which this invention belongs. Where a measurement is followed by the notation “(+10%)” or “(+3%)”, the measurement may vary within the indicated percentage either positively or negatively. This variance may be manifested in the sample as a whole (e.g., a sample that has a uniform width that is within the indicated percentage of the stated value), or by variation(s) within the sample (e.g., a sample having a variable width, all such variations being within the indicated percentage of the stated value).

While typical embodiments have been set forth for the purpose of illustration, the foregoing descriptions should not be deemed to be a limitation on the scope of the invention. Accordingly, various modifications, adaptations, and alternatives may occur to one skilled in the art without departing from the spirit and scope of the present invention.

What is claimed is:

1. A fiber comprising a thermoplastic composition comprising:
from 60 to 99% by weight of an organic polymer; and
from 0.5 to 40% by weight of a conductive filler.

2. The fiber of claim 1, wherein the fiber has a resistance equal to or less than 10¹⁰ ohms.

3. The fiber of claim 2, wherein the fiber has a resistance equal to or less than 10⁶ ohms.

4. The fiber of claim 1, wherein the fiber has a specific resistance equal to or less than 10⁶ ohm-cm.

5. The fiber of claim 4, wherein the fiber has a specific resistance equal to or less than 10³ ohm-cm.

6. The fiber of claim 1, wherein the fiber has an average diameter of from 0.08 to 0.5 mm.

7. The fiber of claim 1, wherein the fiber has an average diameter with a standard deviation of about 0.02 mm or less along a length of the fiber such that the fiber has a substantially smooth appearance.

8. The fiber of claim 1, wherein the organic polymer is an amorphous polymer selected from polycarbonates, polyethersulfones, polysulfonates, polyetherimides, poly (p-phenylene oxide); polyamideimides, atactic polystyrene, polyarylsulfones, polyvinyl chlorides, or a combination comprising at least one of the foregoing amorphous polymers.

9. The fiber of claim 1, wherein the organic polymer is a semi-crystalline polymer selected from polyesters, polyamides, polyphthalamide; polyphenylene sulfides; polyether etherketones; polyetherketones; polyether ketone ketones, liquid crystal polymers, polyimides, polyacetals, syndiotactic polystyrene, polyacrylics, polyarylates, polytetrafluoroethylenes; polysulfonates; polyvinyl alcohols, polysulfonamides, polysilazanes, polyphosphazenes, polyureas, or a combination comprising at least one of the foregoing semi-crystalline polymers.

10. The fiber of claim 1, wherein the organic polymer is selected from polyetherimide, polybutylene terephthalate, and an permanent anti-static agent, such as polyamide/polyetheramide copolymer, or a combination comprising at least one of the foregoing organic polymers.

11. The fiber of claim 10, wherein the organic polymer comprises a mixture of polybutylene terephthalate and a permanent anti-static agent and wherein the permanent anti-static agent is present in an amount from 1 to 40% by weight of the total weight of the thermoplastic composition.

12. The fiber of claim 11, wherein the permanent anti-static agent comprises a polyamide/polyetheramide copolymer.

13. The fiber of claim 11, wherein the permanent anti-static agent is present in an amount from 10 to 35% by weight of the total weight of the thermoplastic composition.

14. The fiber of claim 1, wherein the conductive filler is selected from low-structure carbon black, single-wall carbon nanotubes, multi-wall nanotubes, vapor-grown carbon fibers, metal coated small carbon fibers, metal coated mineral particles with an average particle size smaller than 2 microns or a combination comprising at least one of the foregoing conductive fillers.

15. The fiber of claim 14, wherein the conductive filler comprises low-structure carbon black having a surface area less than 300 m²/g.

16. The fiber of claim 1, wherein the conductive filler is present in an amount of from 2 to 20% by weight of the total weight of the thermoplastic composition.

17. The fiber of claim 1, further comprising an additive selected from a flame retardant agent, an antidrip agent, a heat stabilizer, a light stabilizer, an antioxidant, a plasticizer, an antistat agent, a mold release agent, a UV absorber, a lubricant, a pigment, a dye, a colorant, or combinations including one or more of the foregoing additives.

18. An article of manufacture comprising the fiber of claim 1.

19. The article of manufacture of claim 8, wherein the article is selected from a conveyor belt, an article of clothing or fabric, or an electronic part handling device.
